(19) United States
(12) Patent Application Publication
(10) Pub. No.: US 2007/0124969 A1
(43) Pub. Date: Jun. 7, 2007

(54) Bound component with variable indicia

(76) Inventors: Edward P. Busam, Mason, OH (US); Diana W. Juratovac, Columbus, OH (US)

Correspondence Address: THOMPSON HINE L.L.P., P.O. BOX 8801, DAYTON, OH, 45401-8801, US

(21) Appl. No.: 11/291,422

(22) Filed: Dec. 1, 2005

(51) Int. Cl. G09F 11/04

(52) U.S. Cl. 40/495

(57) ABSTRACT

A bound component including a variable display component coupled to an outer cover of the bound component. The display component includes indicia located thereon, and only part of the indicia is visible from outside the bound component. The display component is manually manipulable to change the part of the indicia that is visible from outside the bound component, and the display component is configured to be uncoupled from the outer cover.

The present invention is directed to a bound component, and more particularly, to a bound component with indicia on the cover which can be changed or varied.

### BACKGROUND

Bound components, such as notebooks, binders, books, address books, planners, diaries, journals and the like are widely used to record various information. However, in typical use of these bound components, information is written on the inside of the bound component (i.e., on the bound pages). The information written thereon is not readily viewable from outside the bound component.

Some bound components may include an outer cover which can be written upon such that the information is more readily viewable. However, such a method typically permanently mars the outer cover. Accordingly, there is a need for a bound component which can display variable indicia that is viewable from outside the bound component.

### SUMMARY

In one embodiment, the present invention is a bound component which displays various indicia that is viewable from outside the bound component. In particular, in one embodiment, the invention is a bound component including a variable display component coupled to an outer cover of the bound component. The display component includes indicia located thereon, and only part of the indicia is visible from outside the bound component. The display component is manually manipulable to change the part of the indicia that is visible from outside the bound component, and the display component is configured to be uncoupled from the outer cover.

### BRIEF DESCRIPTION OF THE DRAWINGS

FIG. 1 is a front perspective view of one embodiment of the bound component of the present invention, with the display wheel in a first position;

FIG. 2 is a top view of the bound component of FIG. 1, with the display wheel in a second position;

FIG. 3 is a front perspective view of the bound component of FIG. 1, with the display wheel laterally exploded away from the front cover;

FIG. 4 is a front perspective view of the bound component of FIG. 1, with portions of the front cover cut away to expose the display wheel;

FIG. 5 is a front perspective view of the bound component of FIG. 4 with the display wheel exploded away from the front cover; and

FIG. 6 is a front perspective view of the notebook of FIG. 1, shown in an open position.

### DETAILED DESCRIPTION

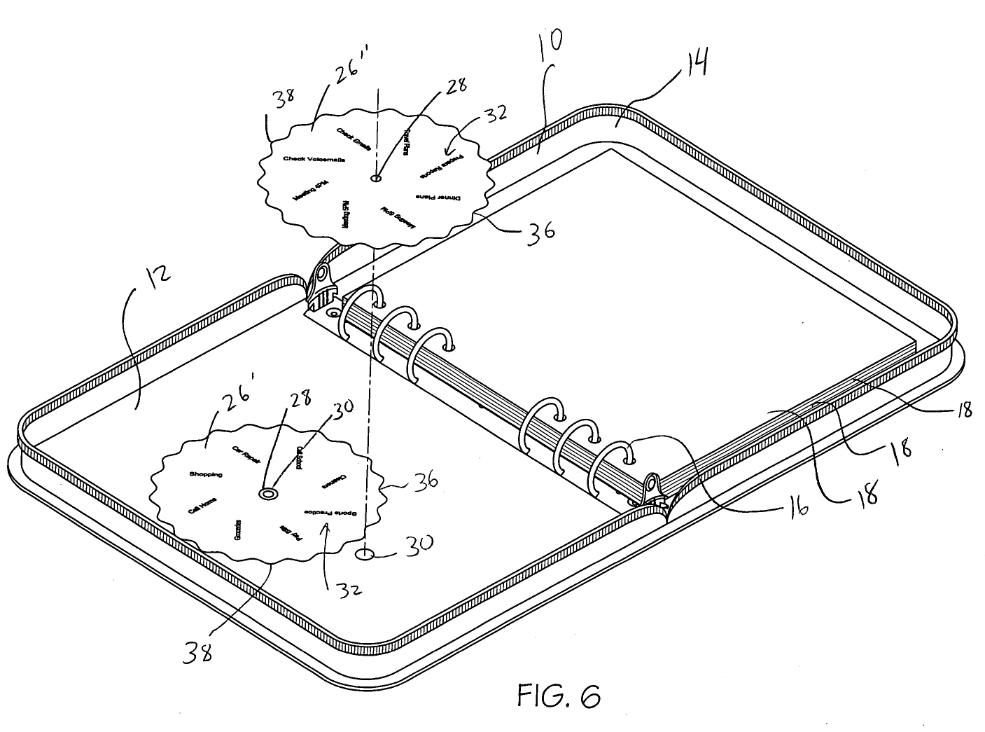

In one embodiment, the bound component 10 of the present invention includes a pair of outer covers in the form of a front cover 12 and a rear cover 14 pivotally coupled together. As shown in FIG. 6, the front 12 and rear 14 covers may be coupled to a binding mechanism 16, such as a three-ring binding mechanism, although the binding mechanism 16 may take a variety of forms, including spiral binding mechanisms, coil binding mechanisms, adhesive binding mechanisms and the like. A plurality of pages 18 (FIG. 6) are bound to the covers 12, 14 by the binding mechanism.

Each of the pages 18 may be made of cellulose-based or pulp-based paper such that the pages 18 can be written upon by a wide variety of writing instruments, such as pens, pencils, markers and the like. The pages 18 may have various indicia preprinted thereon, such as calendar or date indicia (for use in a calendar or planner), address and phone information (for use in an address book), ruled lines (for use in a notebook, journal or the like). Of course, various other indicia may be printed on the pages 18 or, if desired, the pages 18 may not include any indicia preprinted thereon.

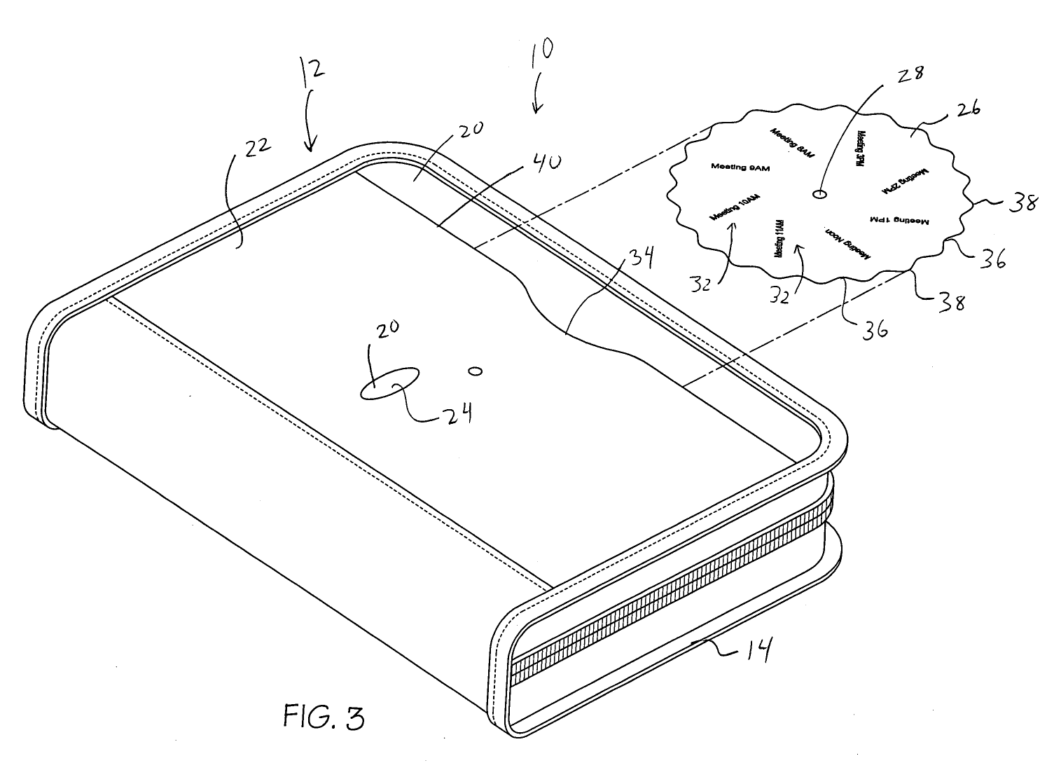

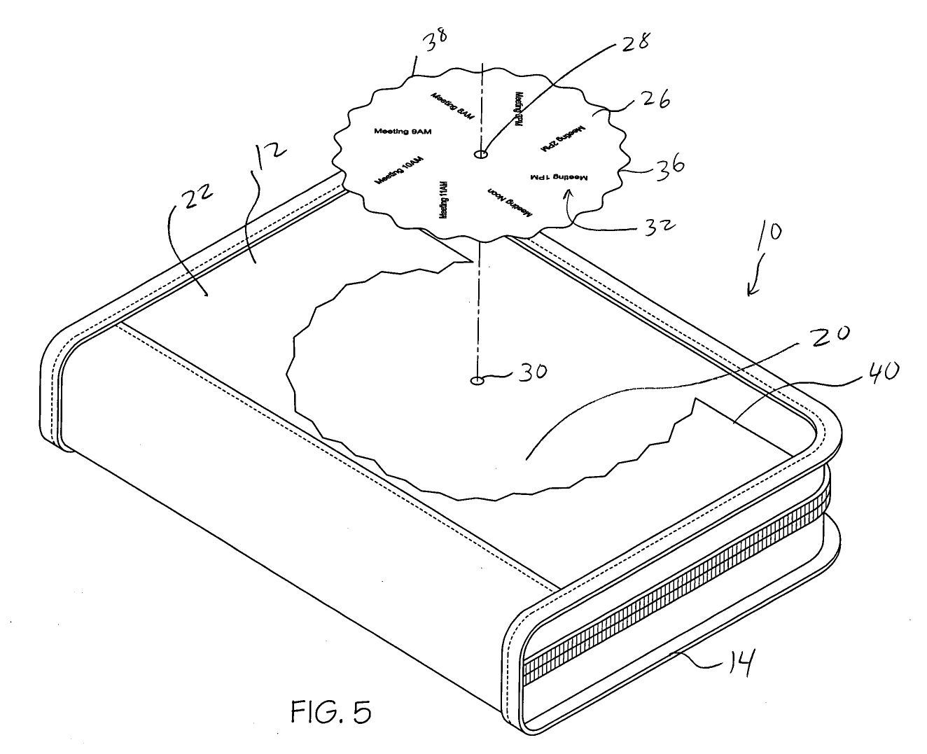

As best shown in FIG. 5, the front cover 12 may include a base panel 20 extending across the entire surface of the front cover 12, and a covering panel 22 which may have a surface area less than the base panel 20. The covering panel 22 faces and is generally parallel with the base panel 20, and includes an opening 24 formed therein (see FIG. 3).

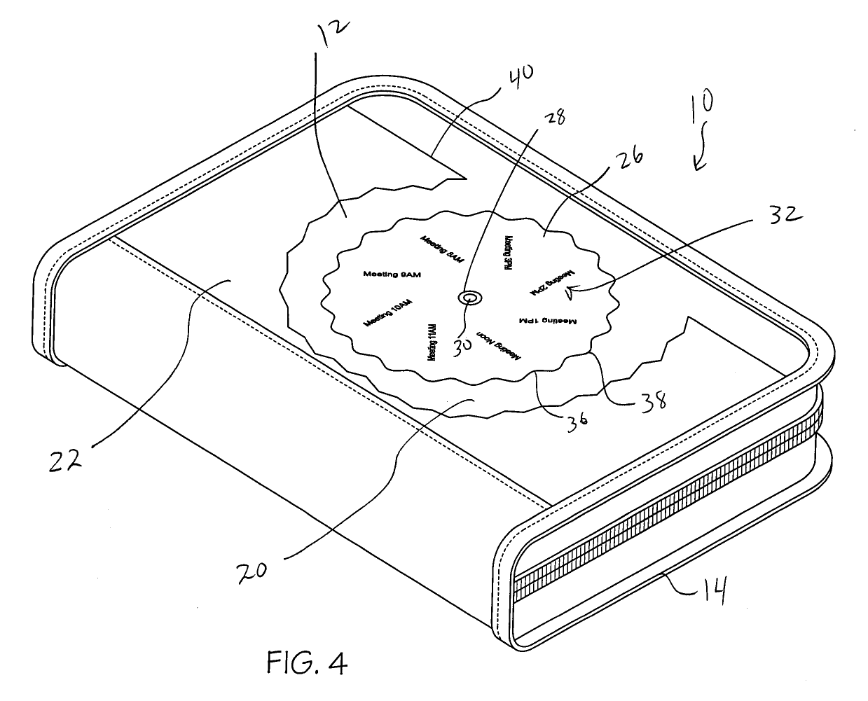

A variable display component 26, such as a display wheel, may be rotatably coupled to the front cover 12 and located between the covering panel 22 and base panel 20. In particular, as shown in FIGS. 4 and 5, the system may include a pair of attachment components 28, 30, in the form of male and female snap components, to rotatably couple the display wheel 26 to the front cover. In the illustrated embodiment, the attachment component 28 is located on the display wheel 26 and at a center thereof to allow smooth and even rotation of the display wheel 26. However, a wide variety of other attachment components for rotatably coupling the display wheel 26 to the front cover 12 may be utilized.

The display wheel 26 may include various indicia 32 printed thereon. For example, in the embodiment shown in FIGS. 4 and 5, the display wheel includes the text “Meeting” with different times of the day printed adjacent thereto. However, the indicia 32 can take any of a wide variety of forms. For example, besides the specific time reminders shown in FIGS. 4 and 5, the indicia 32 may include reminders such as “Dinner Plans,” “Check Emails,” “Pay Bills,” etc. For example, the display wheels 26′, 26″ shown in FIG. 6 (which will be described in greater detail below) includes further examples of indicia 32 which may be located on the display wheel 26.

In addition, the indicia 32 may take a variety of forms besides textual reminders. For example, symbolic, graphical or drawing indicia may be used. Furthermore, the indicia 32 need not take the form of reminders, as various decorative or aesthetically pleasing features, colors, surface textures, patterns and the like may be utilized as indicia 32 on the display wheel 26. In the illustrated embodiment, the display wheel 26 is generally circular and translucent or transparent, although these features may be varied as desired. The indicia 32 may be oriented (i.e., extend) generally radially, and a number of indicia markings 32 may be located on each display wheel 26 (eight separate indicia 32 being located on each wheel 26 in the illustrated embodiment). Alternately, all of the markings on the display wheel 26 (i.e., all eight phrases in the illustrated embodiment) may be considered as one indicia 32, wherein only part of the indicia is visible through the opening 24 at any one time.

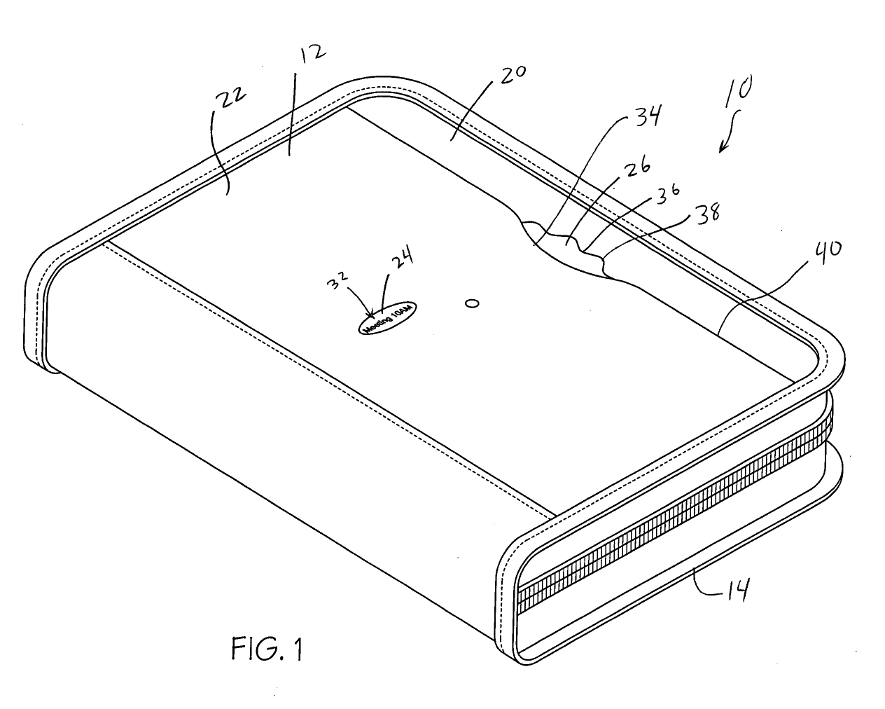

As shown in FIG. 1, when the display wheel 26 is mounted to the front cover 12, the opening 24 of the covering panel 22 is located and configured such that one of the indicia 32 of the display wheel 26 is visible therethrough. In this manner, the bound component 10 provides a reminder which is visible from the outside of the bound component 10 such that the reminder indicia 32 can be easily viewed by the user.

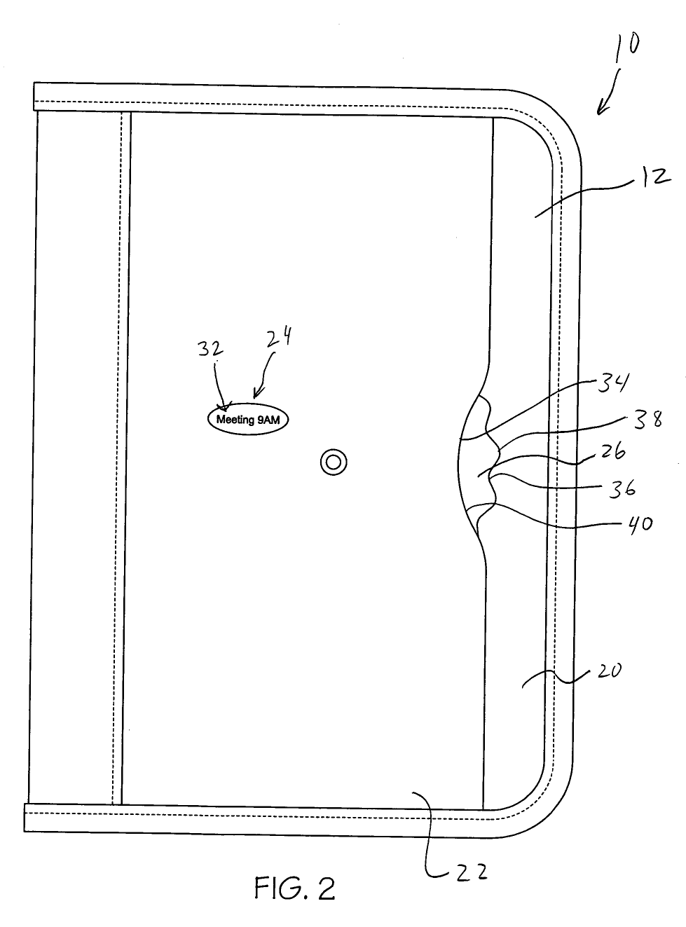

The system of the present invention allows the user to vary the displayed indicia 32 as desired. For example, should the user's meeting change from 10 a.m. to 9 a.m., the display wheel 26 can be rotated counterclockwise until the “Meeting 9 AM” indicia 32 is displayed through the opening 24 (see FIG. 2). Thus, it may be desired to provide at least a portion of the display wheel 26 protruding from under the covering panel 22 and easily accessible to allow rotation of the display wheel 26. In one embodiment, the covering panel 22 includes a recessed area 34 which exposes at least part of the display wheel 26 located thereunder. In the illustrated embodiment, the display wheel 26 includes a plurality of notches 36/protrusions 38 formed on an outer perimeter thereof to provide a gripping surface for ease of rotating the display wheel 26.

In this manner, when the display wheel 26 is mounted to the front cover 12, only part of the indicia 32 on that wheel 26 is visible from outside the bound component 10, and the display component 26 is manually manipulable to change the part of the indicia 32 that is visible from outside the bound component 10.

Because the display wheel 26 may be removably mounted to the front cover 12, if desired the display wheel 26 may be removed and replaced with another display wheel. For example, as shown in FIG. 3, in order to uncouple the display wheel 26 from the front cover 12, the male and female snap components 28, 30 are separated, and the display wheel 12 is slid laterally through an open edge 40 defined between the base panel 20 and the covering panel 22. A replacement display wheel 26 can then be slid laterally into the cavity located between the base panel 20 and the covering panel 22, and the snap components 28, 30 coupled together.

As shown in FIG. 6, if desired replacement display wheels 26′, 26″ may be directly coupled to the bound component 10, such as on an inner surface thereof. In the illustrated embodiment, the display wheels 26′, 26″ are coupled to an inner surface of the front cover 12. The inner surface of the bound component may include attachment components, such as snap components 30 to cooperate with the snap components 28 on the display wheels 26′, 26″ to allow the extra display wheels 26′, 26″ to be rotatably coupled thereto. This provides a user with a greatly increased selection of indicia 32 to be displayed through the window 24.

In this manner the bound component 10 can be utilized to display information that is readily viewable, even when the bound component 10 remains closed. The displayed information can also be easily adjusted as desired. Further, because the display wheel 26 is spaced inwardly from the outer edges and surfaces of the bound component 10, the display wheel 26 avoids being inadvertently shifted or rotated.

Having described the invention in detail and by reference to the preferred embodiments, it will be apparent that modifications and variations thereof are possible without departing from the scope of the invention.

What is claimed is:

1. A bound component including a variable display component coupled to an outer cover of said bound component, wherein said display component includes indicia located thereon, and wherein only part of said indicia is visible from outside said bound component, and wherein said display component is manually manipulable to change the part of said indicia that is visible from outside said bound component, and wherein said display component is configured to be uncoupled from said outer cover.

2. The bound component of claim 1 wherein said display component is rotatably coupled to said outer cover.

3. The bound component of claim 1 wherein said display component and said outer panel each have an attachment component located thereon, and wherein said attachment components are configured to cooperate to rotatably couple said display component to said outer panel.

4. The bound component of claim 3 wherein one of said attachment components is a male snap component and the other one of said attachment components is a female attachment component.

5. The bound component of claim 3 wherein said attachment component of said display component is located generally at a center of said display component.

6. The bound component of claim 1 wherein said display component is generally circular in front view.

7. The bound component of claim 6 wherein said display component has a plurality of notches or protrusions formed in an outer perimeter thereof.

8. The bound component of claim 1 wherein said display component is rotatable to change the indicia that is visible from outside said bound component.

9. The bound component of claim 1 wherein said outer cover includes a covering panel and an opening formed in said covering panel through which said part of said indicia is visible from outside said bound component.

10. The bound component of claim 9 wherein said outer cover includes a base panel that is facing and generally parallel with said covering panel, and wherein said display component is generally located between said base panel and said covering panel.

11. The bound component of claim 10 wherein said base panel and said covering panel define an open edge therebetween, and wherein said display component can be removed from said outer cover by sliding said display component through said open edge.

12. The bound component of claim 10 wherein said covering panel has a smaller surface area than said base panel.

13. The bound component of claim 1 wherein said covering panel includes a recessed area which exposes at least part of said display component located therebelow.

14. The bound component of claim 1 wherein said display component has a predetermined number of discreet indicia portions located thereon, and wherein only one of said indicia portions is visible from outside said bound component at any given time.

15. The bound component of claim 14 wherein said indicia includes textual reminders.

16. The bound component of claim 1 further comprising a supplemental variable display component configured to be coupled to said front cover, wherein said supplemental display component includes indicia located thereon such that only part of said indicia is visible from outside said bound component when said supplemental display component is coupled to said front cover, and wherein said supplemental display component is manually manipulable to change the part of said indicia that is visible from outside said bound component when said supplemental display component is coupled to said front cover.

17. The bound component of claim 16 wherein said supplemental display component is coupled to an inner surface of said bound component.

18. The bound component of claim 17 wherein said supplemental display component is rotatably coupled to said inner surface.

19. The bound component of claim 1 further comprising a plurality of pages bound to said outer cover.

20. The bound component of claim 19 further comprising a binding mechanism coupling said papers together and to said outer cover.

21. The bound component of claim 19 further comprising a supplemental outer cover pivotally coupled to said outer cover, and wherein said supplemental outer cover is movable to a closed position wherein said outer cover and said supplemental outer cover are generally parallel and spaced apart and said plurality of pages are positioned between said outer cover and said supplemental outer cover.

22. The bound component of claim 21 wherein said part of said indicia is visible from outside said bound component when said bound component is in said closed position.

23. The bound component of claim 21 wherein said bound component is a personal planner.

24. The bound component of claim 1 wherein at least part of said display component is exposed such that a user can access said exposed part of said display component to manually manipulate said display component.

25. A bound component including:
a front cover; and
a rear cover;
a variable display component configured to be coupled to said front cover, wherein said display component includes indicia located thereon, and wherein only part of said indicia is visible from outside said bound component when said display component is coupled to said front cover, and wherein said display component is manually manipulable to change the part of said indicia that is visible from outside said bound component when said display component is coupled to said front cover, and wherein said display component is configured to be removably coupled to said front cover.

26. An planner comprising:
an outer cover;
a plurality of pages bound to said outer cover, each page having calendar indicia printed thereon; and
a variable display component coupled to said outer cover, wherein said display component includes reminder indicia located thereon, and wherein only part of said reminder indicia is visible from outside said bound component, and wherein said display component is manually manipulable to change the part of said reminder indicia that is visible from outside said bound component.

27. A method for manipulating a bound component comprising the steps of:
providing a bound component including a variable display component coupled to an outer cover of said bound component, wherein said display component includes indicia located thereon, and wherein only part of said indicia is visible from outside said bound component, and wherein said display component and is configured to be uncoupled from said outer cover; and
manually manipulating said display component to change the part of said indicia that is visible from outside said bound component.

28. The method of claim 27 further comprising the steps of separating said display component from said bound component, and coupling a supplemental display component to said bound component, wherein said supplemental display component includes indicia located thereon, and wherein only part of said indicia of said supplemental display component is visible from outside said bound component.
